(19) United States
(12) Patent Application Publication
(10) Pub. No.: US 2014/0218968 A1
(43) Pub. Date: Aug. 7, 2014

(54) PLANAR LIGHTING DEVICE

(71) Applicant: NATIONAL CENTRAL UNIVERSITY, Taoyuan Country (TW)

(72) Inventors: Ching-Cherng SUN, Taoyuan County (TW); Chi-Shou WU, Taoyuan County (TW)

(73) Assignee: NATIONAL CENTRAL UNIVERSITY, Taoyuan County (TW)

(21) Appl. No.: 13/954,986

(22) Filed: Jul. 31, 2013

(30) Foreign Application Priority Data
Feb. 5, 2013 (TW) 10214427

(51) Int. Cl. F21V 8/00

(52) U.S. Cl. CPC G02B 6/0011
USPC 362/612; 362/617

(57) ABSTRACT

A planar lighting device includes a light guide plate and a side-emitting lighting module. The light guide plate includes a light emission surface, a back light surface, and at least one side surface. The back light surface is opposite to the light emission surface, and the side surface extends between the light emission surface and the back light surface. The side-emitting lighting module is embedded into the light guide plate, such that the side-emitting lighting module emits light toward the side surface of the light guide plate. The light is then guided by the light guide plate and emerges from the light emission surface of the light guide plate.

### RELATED APPLICATIONS

This application claims priority to Taiwanese Application Serial Number 102104427, filed Feb. 5, 2013, which is herein incorporated by reference.

### BACKGROUND

1. Technical Field

The present disclosure relates to a planar lighting device.

2. Description of Related Art

A back light source of a typical display panel can employ a direct-type back light module or an edge-type back light module. A light emitting element of the direct-type back light module is disposed below a light emission surface of the direct-type back light module, and light can emerge from right beneath the light emission surface. The direct-type back light module not only has a simple structure, but also can be employed in a large back light source. However, because of limitations in the normal light intensity of the light emitted from the light emitting element of the direct-type back light module, the brightness of the direct-type back light module may be non-uniform. Therefore, the direct-type back light module must include a diffuser to enable light to be emitted uniformly. However, such a diffuser may increase the thickness of the direct-type back light module.

As for the edge-type back light module, a light emitting element thereof is disposed at sides of a light guide plate of the edge-type back light module, such that light emits to sides of the light guide plate. Since the light emitting element is disposed at the sides of the light guide plate, and light is propagated in the light guide plate utilizing the total internal reflection of the light guide plate, the thickness of the edge-type back light module is determined by the thickness of the light guide plate. Therefore, the thickness of the edge-type back light module can be smaller than the thickness of the direct-type back light module. However, the edge-type back light module is not suitable for a back light source used in a large display panel since the brightness of the light guide plate is decreased as a lateral distance of the light guide plate from the light emitting element is increased. In addition, the refractive index of the light emitting element disposed in the air is unmatched to the light guide plate which can cause Fresnel reflection, thereby leading to a reduction in the optical coupling efficiency of the light emitting module to the light guide plate, and a loss in the overall light energy. Therefore, many in the field are endeavoring to design a light guide plate in a manner that enhances the brightness of the edge-type back light module.

### SUMMARY

A planar lighting device includes a light guide plate and a side-emitting lighting module. The light guide plate includes a light emission surface, a back light surface, and at least one side surface. The back light surface is opposite to the light emission surface, and the side surface extends between the light emission surface and the back light surface. The side-emitting lighting module is embedded into the light guide plate, such that the side-emitting lighting module emits light toward the side surface of the light guide plate. The light is then guided by the light guide plate and emerges from the light emission surface of the light guide plate.

In one or more embodiments, two reflective layers can respectively be coated on a side facing the light emission surface and on a side facing the back light surface.

In one or more embodiments, the side-emitting lighting module optionally further includes a light emitting element and a substrate stacked on the light emitting element. One of the reflective layers is adjacent to the light emitting element, and the other of the reflective layers is adjacent to the substrate.

In one or more embodiments, the side-emitting lighting module optionally further includes a plurality of microstructures disposed between the light emitting element and the substrate, or disposed between the light emitting element and the reflective layer adjacent to the light emitting element.

In one or more embodiments, the microstructures can be pyramid array microstructures, lens array microstructures, or any combination thereof.

In one or more embodiments, the reflective layers can be metal conductive layers.

In one or more embodiments, the planar lighting device optionally further includes a bump disposed between the side-emitting lighting module and the back light surface of the light guide plate. The bump has a top surface, a bottom surface opposite to the top surface, and at least one reflective surface extending between the top surface and the bottom surface. An area of the top surface is smaller than an area of the bottom surface. The bottom surface is adjacent to the back light surface of the light guide plate. The top surface is adjacent to the side-emitting lighting module, and the top surface is disposed within an area of a side of the side-emitting lighting module adjacent to the bump.

In one or more embodiments, an angle between the reflective surface of the bump and the bottom surface of the bump can be 10 degrees to 20 degrees.

In one or more embodiments, the side-emitting lighting module can be a blue light-emitting diode, a green light-emitting diode, a red light-emitting diode, an ultraviolet light-emitting diode, or any combination thereof.

In one or more embodiments, the planar lighting device optionally further includes a wavelength conversion layer disposed at outside of the light emission surface.

### BRIEF DESCRIPTION OF THE DRAWINGS

FIG. 1 is a schematic diagram of a planar lighting device according to a first embodiment of the present invention;

FIG. 2 is a schematic diagram of a side-emitting lighting module of FIG. 1;

FIG. 3 to FIG. 6 are schematic diagrams of the side-emitting lighting module according to plural embodiments of the present invention;

FIG. 7 is a schematic diagram of a light emitting element and adjacent elements according to one embodiment of the present invention;

FIG. 8 is a schematic diagram of the planar lighting device according to a second embodiment of the present invention;

FIG. 9 is a magnified diagram of area P of FIG. 8;

FIG. 10 is a schematic diagram of the planar lighting device according to a third embodiment of the present invention; and

FIG. 11 is a schematic diagram of the planar lighting device according to a fourth embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

FIG. 1 is a schematic diagram of a planar lighting device according to a first embodiment of the present invention. The planar lighting device includes a light guide plate 100 and a side-emitting lighting module 200. The light guide plate 100 has a light emission surface 112 a back light surface 114, and at least one side surface 116. The back light surface 114 is opposite to the light emission surface 112, and the side surface 116 extends between the light emission surface 112 and the back light surface 114. The side-emitting lighting module 200 is embedded into the light guide plate 100, such that the side-emitting lighting module 200 can emit light toward the side surface 116 of the light guide plate 100. The light then guided by the light guide plate 100 and emerges from the light emission surface 112 of the light guide plate 100.

To facilitate the description to follow, a direction parallel to the light emission surface 112 and the back light surface 114 is defined as a lateral direction, and a direction perpendicular to the light emission surface 112 and the back light surface 114 is defined as a vertical direction. The light emitted from the side-emitting lighting module 200 of this embodiment substantially propagates along the lateral direction first. After being guided by the light guide plate 100, the light can propagate along the vertical direction and emerge from the light emission surface 112. “Substantially propagates along the lateral direction” above refers to light without a vertical direction component, or to light with a portion having a vertical direction component and with a portion having a lateral direction component, in which the amount of the portion having a vertical direction component is less than the amount of the portion having a lateral direction component, such that the light can be regarded as propagating along the lateral direction.

A light emitting module of a conventional direct-type back light module is disposed below a light emission surface of the direct-type back light module. In addition, since the light of the conventional direct-type back light module emits vertically, light spots are generated on the back light module, such that the brightness of the light emission surface is not uniform. However, in this embodiment, since the light of the side-emitting lighting module 200 emits laterally, the light can propagate uniformly in the light guide plate 100 due to the total internal reflection on the light emission surface 112. The light can subsequently emerge vertically from the light emission surface 112 after being guided by the light guide plate 100. Hence, the planar lighting device in this embodiment is a direct-type back light module with uniform light emission. In addition, in contrast to the conventional direct-type back light module, the thickness of the back light module in this embodiment is determined by the thickness of the light guide plate 100. Moreover, since the side-emitting lighting module 200 is directly embedded into the light guide plate 100, the light emission efficiency of the side-emitting lighting module 200 can be raised (details in this regard will be described below), such that the disadvantages associated with the conventional direct-type back light module and the conventional edge-type back light module can be avoided.

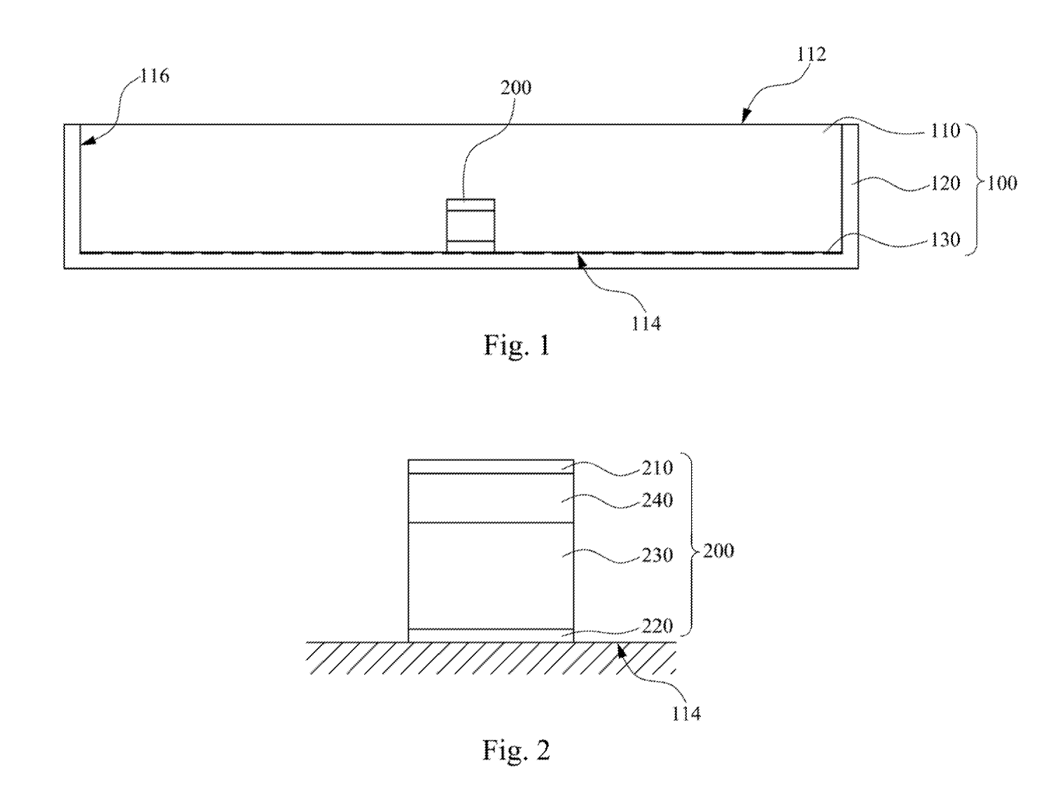

FIG. 2 is a schematic diagram of the side-emitting lighting module 200 of FIG. 1. The side-emitting lighting module 200 can include two reflective layers 210 and 220 that enable side emission of light (i.e., the emission of light in the lateral direction). The reflective layers 210 and 220 are disposed on two surfaces of the side-emitting module 200 respectively facing the light emission surface 112 (see FIG. 1) and the back light surface 114 (see FIG. 1). When the side-emitting lighting module 200 emits light, the light propagating vertically is reflected back to the side-emitting lighting module 200 by the reflective layers 210 and/or 220, and only the light emitted from sides of the side-emitting lighting module 200, i.e., the surfaces without the reflective layer 210 or 220 disposed thereon, can leave the side-emitting lighting module 200 to achieve side emission of light.

The light emitting module in a conventional edge-type back light module is typically adjacent to sides of a light guide plate of the edge-type back light module. Even though the light emitting module is disposed immediately adjacent to the light guide plate in such a conventional edge-type back light module, an air gap is formed between the light emitting module and the light guide plate. In this case, the refractive indices of the light guide plate and the air are not matched, such that a Fresnel reflection is present between the light guide plate and the air. The optical coupling efficiency of the light emitting module to the light guide plate is reduced due to the limitations encountered as a result of such a Fresnel reflection.

However, in this embodiment, the side-emitting lighting module 200 is embedded into the light guide plate 100, i.e., there is no air gap between side-emitting lighting module 200 and the light guide plate 100. In some embodiments, the side-emitting lighting module 200 may further include a substrate 230. The substrate 230 has a first refractive index, the light guide plate 100 has a second refractive index, and the air has a third refractive index. The absolute refractive index difference between the first refractive index and the second refractive index is smaller than the absolute refractive index difference between the first refractive index and the third refractive index. Since the light emission efficiency of the side-emitting lighting module 200 is related to the unmatched refractive indices between the side-emitting lighting module 200 and the environmental medium, a reduction in the unmatched refractive indices of the side-emitting lighting module 200 and the light guide plate 100 results in a higher light emission efficiency of the side-emitting lighting module 200. As an example, the material of the substrate 230 of the side-emitting lighting module 200 can be sapphire with a refractive index of about 1.78, the material of the light guide plate 100 can be Polymethylmethacrylate (PMMA) with a refractive index of about 1.49, and the refractive index of air is 1. Therefore, the unmatched refractive indices in the interface between the side-emitting lighting module 200 and the light guide plate 100 is smaller than that in the interface between the side-emitting lighting module 200 and air. It should be understood that the aforementioned materials of the substrate 230 and the light guide plate 100 are illustrative only, and should not limit the scope of the present invention. A person having ordinary skill in the art may select proper materials for the substrate 230 and the light guide plate 100 according to actual requirements.

In one or more embodiments, the side-emitting lighting module 200 can further include the substrate 230 and a light emitting element 240 in a stacked configuration (e.g., the light emitting element 240 is disposed or stacked on the substrate 230). The reflective layer 210 is adjacent to the light emitting element 240, and the reflective layer 220 is adjacent to the substrate 230. The light emitting element 240 is used for emitting light, and the substrate 230 is used for supporting the light emitting element 240. The light emitted from the light emitting element 240 can propagate to the substrate 230, and then emerge from sides of the substrate 230.

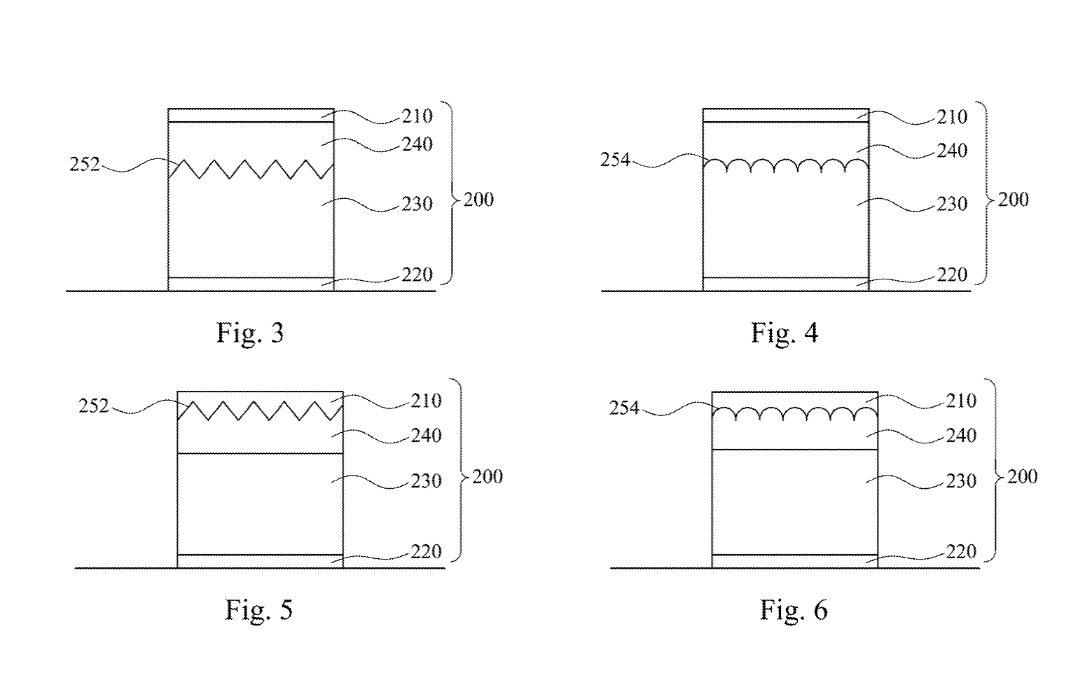

FIG. 3 to FIG. 6 are schematic diagrams of the side-emitting lighting module 200 according to plural embodiments of the present invention. In one or more embodiments, the side-emitting lighting module 200 can further include a plurality of microstructures for enhancing the light emission efficiency of the side-emitting lighting module 200, and changing the directionality of the light. However, the microstructures should not limit the scope of the present invention. The microstructures can be pyramid array microstructures 252 disposed between the light emitting element 240 and the substrate 230, as shown in FIG. 3; lens array microstructures 254 disposed between the light emitting element 240 and the substrate 230, as shown in FIG. 4; pyramid array microstructures 252 disposed between the light emitting element 240 and the reflective layer 210, as shown in FIG. 5; or lens array microstructures 254 disposed between the light emitting element 240 and the reflective layer 210, as shown in FIG. 6. It should be understood that the aforementioned configurations for the side-emitting lighting modules 200 are illustrative only, and should not limit the scope of the present invention. In one or more embodiments, the microstructures can be disposed both between the light emitting element 240 and the substrate 230 and between the light emitting element 240 and the reflective layer 210. In addition, the microstructures can be any combination of the pyramid array microstructures 252 and the lens array microstructures 254. All such variations fall within the scope of the present invention.

In one or more embodiments, the side-emitting lighting module 200 can be a blue light emitting diode, a green light emitting diode, a red light emitting diode, an ultraviolet light emitting diode, or any combination thereof. It should be understood that the aforementioned diode types of the side-emitting lighting module 200 are illustrative only, and should not limit the scope of the present invention. A person having ordinary skill in the art may select the type of the side-emitting lighting module 200 according to actual requirements.

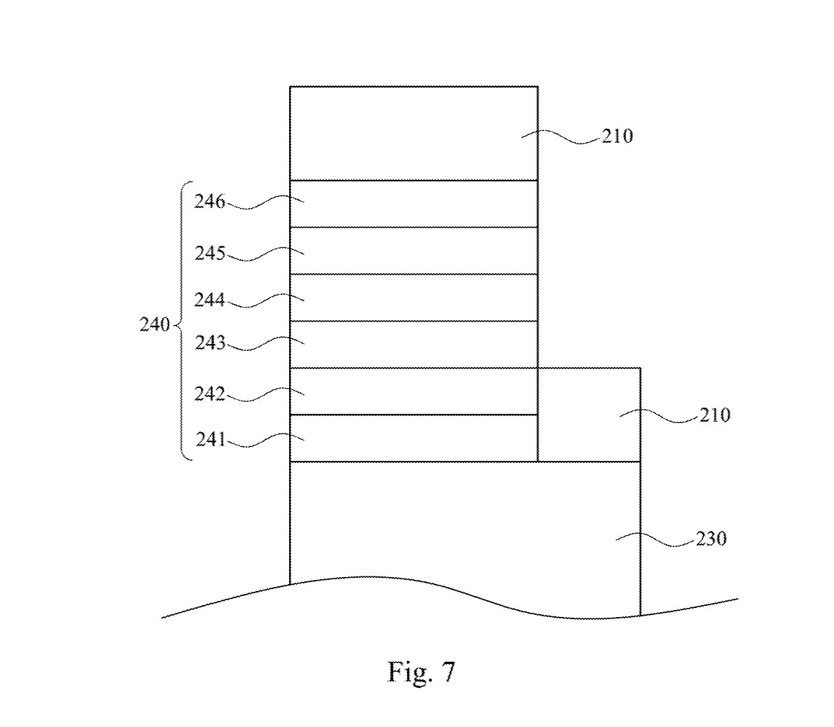

FIG. 7 is a schematic diagram of the light emitting element 240 and adjacent elements according to one embodiment of the present invention. Taking the blue light emitting diode as an example, the light emitting element 240 can be composed of plural semiconductor layers stacked on top of each other. In this embodiment, the semiconductor layers disposed starting from the substrate 230 and extending to the reflective layer 210 are, in sequence, an undoped GaN (u-GaN) layer 241, an n-type GaN (n-GaN) layer 242, an AlGaN layer 243, an InGaN layer 244, an AlGaN layer 245, and a p-type GaN (p-GaN) layer 246. However, the aforementioned structure does not limit the scope of the present invention. After finishing the manufacture of the semiconductor layers of the light emitting element 240, a portion of the reflective layer 210, which may be a metal conductive layer for example, can be coated on the light emitting element 240, and a portion of the reflective layer 210 may cover the substrate 230. Therefore, a bias voltage can be applied between the portion of the reflective layer 210 on the light emitting element 240 and the portion of the reflective layer 210 on the substrate 230 to activate the light emitting element 240, such the light emitting element 240 emits light. In addition, the reflective layer 220 (see FIG. 2) can also be a metal conductive layer, and such a configuration falls within the scope of the present invention.

Referring back to FIG. 1, the light guide plate 100 can include a light guide plate body 110, a reflective mirror 120, and a light guide element 130. The light guide plate body 110 may be made of PMMA, and forms a space for accommodating light. The reflective mirror 120 surrounds all areas of the light guide plate body 110 except the light emission surface 112 of the light guide plate 110, such that the light in the light guide plate body 110 can emerge from the light emission surface 112. The light guide element 130 prevents total internal reflection in the light guide plate 100, such that the light can emerge from the light emission surface 112. The light guide element 130 can be a printing dot array, but the scope of the present invention is not limited by such a configuration.

In the following paragraphs, the structural details of the planar lighting device described previously will not repeated, and only information not supplied above will be described.

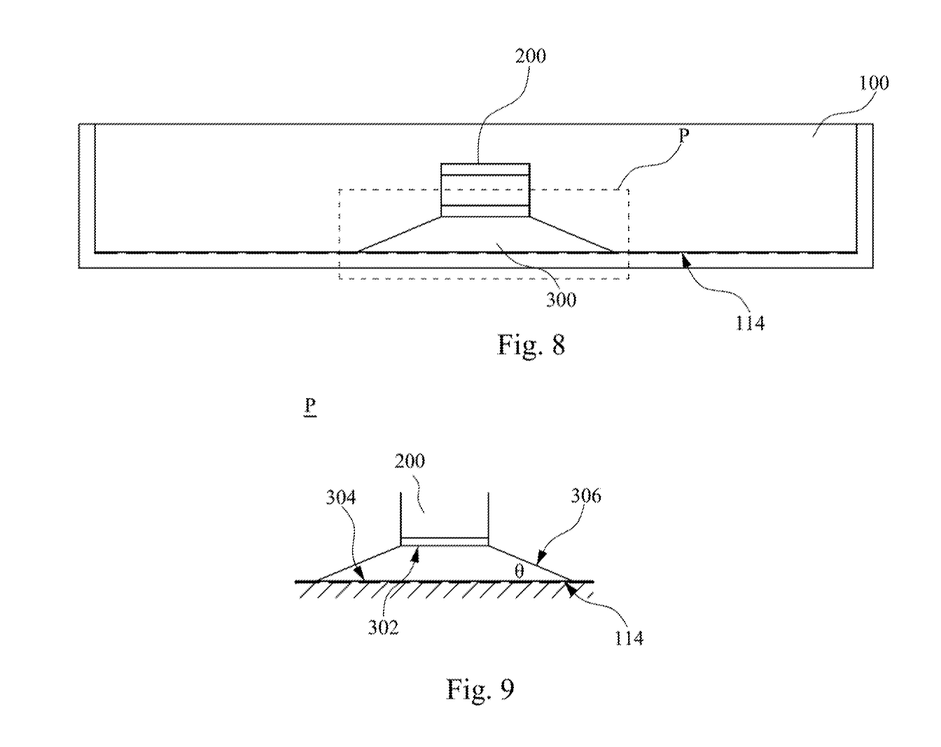

FIG. 8 is a schematic diagram of the planar lighting device according to a second embodiment of the present invention. FIG. 9 is a magnified diagram of area P of FIG. 8. The difference between the second embodiment and the first embodiment is that the second embodiment further comprises a bump 300 for enhancing the lateral component of the light emitted from the side-emitting lighting module 200. That is, in one or more embodiments, the planar lighting device can further include the bump 300 disposed between the side-emitting lighting module 200 and the back light surface 114 of the light guide plate 100. The bump 300 has a top surface 302, a bottom surface 304, and at least one reflective surface 306. The bottom surface 304 is opposite to the top surface 302, and the reflective surface 306 extends between the top surface 302 and the bottom surface 304. The reflective surface 306 is used for reflecting the light emerging from the side-emitting lighting module 200, such that the lateral component of the light can be enhanced. The top surface 302 is adjacent to the side-emitting lighting module 200, and the bottom surface 304 is adjacent to the back light surface 114 of the light guide plate 100. The area of the top surface 302 is smaller than the area of the bottom plate 304, and the top surface 302 is disposed within the area of a side of the side-emitting lighting module 200 adjacent to the bump 300. Therefore, the light propagating from the side-emitting lighting module 200 to the bump 300 can impinge on the reflective surface 306 of the bump 300 rather than on the top surface 302.

An angle θ between the reflective surface 306 and the bottom surface 304 of the bump 300 can be 10 degrees to 20 degrees to achieve better reflection, i.e., most of the light propagating from the side-emitting lighting module 200 to the bump 300 can propagate laterally. In some embodiments, the angle θ is 20 degrees. However, the range of the angle θ should not limit the scope of the present invention. The angle θ is not limited as long as the lateral component of the light propagating from the side-emitting lighting module 200 to the bump 300 can be enhanced. Other structural details of the planar lighting device of this embodiment are the same as those of the first embodiment, and, therefore, will not be repeated hereinafter.

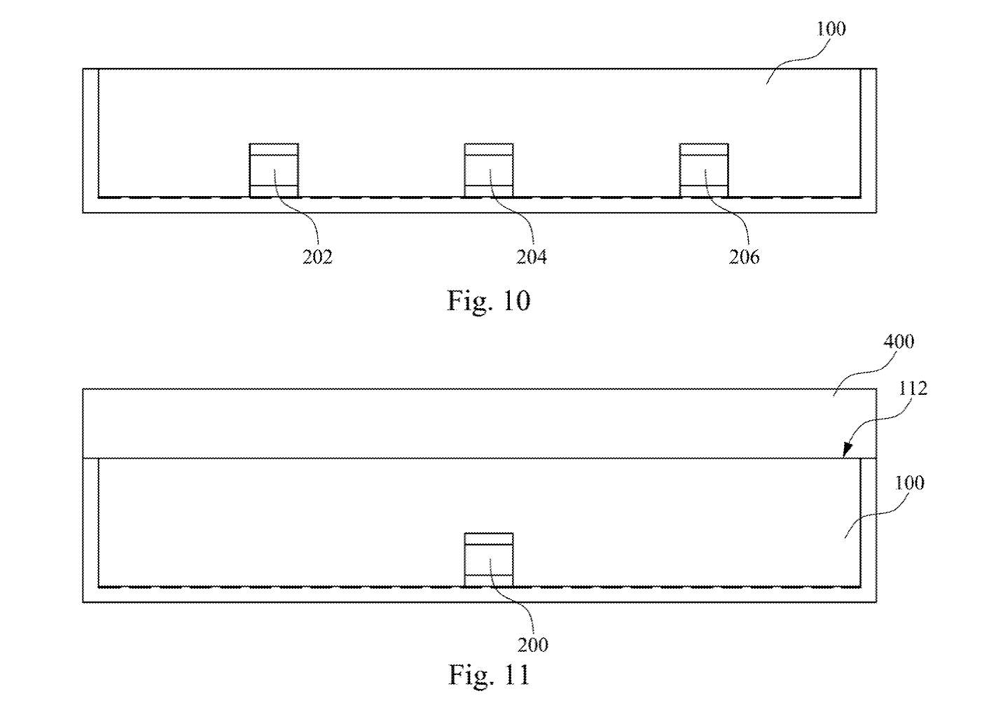

FIG. 10 is a schematic diagram of the planar lighting device according to a third embodiment of the present invention. The difference between the third embodiment and the first embodiment relates to the number and the type of the side-emitting lighting module 200. In particular, in one or more embodiments, the number of the side-emitting lighting module 200 can be plural. In this embodiment, the planar lighting device includes a light guide plate 100 and a plurality of the side-emitting lighting modules 200. The side-emitting lighting modules 200 can be a blue light emitting diode 202, a green light emitting diode 204, and a red light emitting diode 206. The blue light emitting diode 202, the green light emitting diode 204, and the red light emitting diode 206 can be disposed on the back light surface 114 of the light guide plate 100, such that the blue light emitted from the blue light emitting diode 202, the green light emitted from the green light emitting diode 204, and the red light emitted from the red light emitting diode 206 can emerge from the light emission surface 112 of the light guide plate 100 uniformly and mix to form white light. It should be understood that the scope of the present invention is not limited to such a configuration. In particular, while the planar lighting device of this embodiment is described as generating white light, light with a different color can be generated as needed by combining the side-emitting lighting modules 200. Other structural details of the planar lighting device of this embodiment are the same as those of the first embodiment, and, therefore, will not be repeated hereinafter.

FIG. 11 is a schematic diagram of the planar lighting device according to a fourth embodiment of the present invention. The difference between the fourth embodiment and the first embodiment is that the fourth embodiment further comprises a wavelength conversion layer 400. In one or more embodiments, the planar lighting device can further include the wavelength conversion layer 400 disposed outside of the light emission surface 112 The wavelength conversion layer 400 can absorb light with a first wavelength emitted from the light emission surface 112 of the light guide plate 100, and then converts the light with the first wavelength to light with a second wavelength, such that the color of the light emitted from the planar lighting device can be converted. For example, the side-emitting lighting module 200 can be a blue light emitting diode, and the wavelength conversion layer 400 can be a yellow phosphor layer. After absorbing the blue light emitted from the blue light emitting diode, the yellow phosphor layer can emit yellow light which can be mixed with the remaining blue light to form white light. In other words, the planar lighting device of this embodiment is a white light emitting planar lighting device. Although the aforementioned wavelength conversion layer 400 is described as being a phosphor layer, the wavelength conversion layer 400 can be any wavelength conversion material in other embodiments. Other structural details of the planar lighting device of this embodiment are the same as those of the first embodiment, and, therefore, will not repeated hereinafter.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A planar lighting device, comprising:
a light guide plate having a light emission surface, a back light surface opposite to the light emission surface, and at least one side surface extending between the light emission surface and the back light surface; and
side-emitting lighting module embedded into the light guide plate, such that the side-emitting lighting module emits light toward the side surface of the light guide plate, and the light is then guided by the light guide plate and emerges from the light emission surface of the light guide plate.

2. The planar lighting device of claim 1, wherein the side-emitting lighting module comprises two reflective layers respectively on a side facing the light emission surface and on a side facing the back light surface.

3. The planar lighting device of claim 2, wherein the side-emitting lighting module further comprises a light emitting element and a substrate stacked on the light emitting element, one of the reflective layers is adjacent to the light emitting element, and the other of the reflective layers is adjacent to the substrate.

4. The planar lighting device of claim 3, wherein the side-emitting lighting module further comprises a plurality of microstructures disposed between the light emitting element and the substrate, or disposed between the light emitting element and the reflective layer adjacent to the light emitting element.

5. The planar lighting device of claim 4, wherein the microstructures are pyramid array microstructures, lens array microstructures, or any combination thereof.

6. The planar lighting device of claim 2, wherein the reflective layers are metal conductive layers.

7. The planar lighting device of claim 1 further comprising a bump disposed between the side-emitting lighting module and the back light surface of the light guide plate, wherein the bump has a top surface, a bottom surface opposite to the top surface, and at least one reflective surface extending between the top surface and the bottom surface, an area of the top surface is smaller than an area of the bottom surface, the bottom surface is adjacent to the back light surface of the light guide plate, the top surface is adjacent to the side-emitting lighting module, and the top surface is disposed within an area of a side of the side-emitting lighting module adjacent to the bump.

8. The planar lighting device of claim 7, wherein an angle between the reflective surface of the bump and the bottom surface of the bump is 10 degrees to 20 degrees.

9. The planar lighting device of claim 1, wherein the side-emitting lighting module is a blue light-emitting diode, a green light-emitting diode, a red light-emitting diode, an light-emitting diode, or any combination thereof.

10. The planar lighting device of claim 1, further comprising a wavelength conversion layer disposed outside of the light emission surface.
